(19) United States
(12) Patent Application Publication
(10) Pub. No.: US 2020/0026124 A1
(43) Pub. Date: Jan. 23, 2020

(54) LIQUID CRYSTAL DISPLAY PANEL AND MANUFACTURING METHOD FOR LIQUID CRYSTAL DISPLAY PANEL

(71) Applicant: SHARP KABUSHIKI KAISHA, Sakai City, Osaka (JP)

(72) Inventors: SAORI KUROGANE, Sakai City, Osaka (JP); YASUHIKO SUGIHARA, Sakai City, Osaka (JP); MASAHIRO OKUNO, Sakai City, Osaka (JP)

(21) Appl. No.: 16/499,235

(22) PCT Filed: Mar. 26, 2018
(86) PCT No.: PCT/JP2018/011954

§ 371 Date: Sep. 27, 2019

(30) Foreign Application Priority Data
Mar. 31, 2017 (JP) 2017-071585

(51) Int. Cl. G02F 1/1335; G02F 1/1339

(52) U.S. Cl. CPC G02F 1/133528; G02F 1/133611; G02F 1/1339

(57) ABSTRACT

The present invention provides a liquid crystal display panel in which a decrease in durability and reliability can be inhibited while excellent design ability is maintained. The present invention provides a liquid crystal display panel sequentially including: a first polarizing plate including a first stretched film and provided with a hole; a liquid crystal panel; and a second polarizing plate including a second stretched film and provided with a hole, wherein a machine direction (MD) of the first stretched film is perpendicular to a machine direction (MD) of the second stretched film, a length of the first polarizing plate in a direction perpendicular to the MD of the first stretched film is longer than a length of the second polarizing plate in a direction perpendicular to the MD of the second stretched film, and a thickness of the first stretched film is smaller than a thickness of the second stretched film.

### TECHNICAL FIELD

The present invention relates to a liquid crystal display panel and a method of producing a liquid crystal display panel. More specifically, the present invention relates to a liquid crystal display panel including a polarizing plate provided with a hole, and a method of producing the liquid crystal display panel.

### BACKGROUND ART

Liquid crystal display panels are known to have a structure in which a liquid crystal panel and a polarizing plate are assembled together. Polarizing plates are usually cut out from a roll of raw sheet into rectangles according to the screen size of liquid crystal panels. A common method for cutting polarizing plates is a method that employs a punching die (hereinafter also referred to as a “punching method”) (for example, see Patent Literature 1).

### CITATION LIST

Patent Literature
Patent Literature 1: JP 2007-187781 A

### SUMMARY OF INVENTION

### Technical Problem

Recent versatility of liquid crystal display panels has created an increasing demand for liquid crystal display panels having a shape different from conventional shapes. In response, studies have been made to form a hole in each of two polarizing plates disposed in crossed Nicols at the front and the rear of a liquid crystal panel. However, as a result of studies, the present inventors found that the formation of a hole in the polarizing plates makes the polarizing plates more susceptible to cracking in a durability test (heat shock test). In some cases, light leakage occurred from the polarizing plates because of a crack, decreasing reliability of liquid crystal display panels.

Patent Literature 1 discloses a method of producing an optical film product by the punching method. Patent Literature 1, however, nowhere mentions the crack and is not intended to reduce the occurrence thereof.

The present invention is made in view of the current situation described above, and aims to provide a liquid crystal display panel in which a decrease in durability and reliability can be inhibited while excellent design ability is maintained, and a method of producing the liquid crystal display panel.

### Solution to Problem

The present inventors studied the cause of cracking in the polarizing plates in the durability test of a liquid crystal display panel provided with a hole. FIG. 5 is a schematic perspective view showing a polarizing plate used in an examination experiment. FIG. 6 is a schematic plan view showing a polarizing plate that was cracked in a heat shock test. In FIG. 5 and FIG. 6, the white double-headed arrow near a polarizing plate 40 indicates an absorption axis of the polarizing plate 40. As shown in FIG. 5, the polarizing plate 40 includes a protection film 43 on each surface of a stretched film 42. The contraction force of the stretched film 42 constituting the polarizing plate 40 is smaller than the intermolecular force in a machine direction MD₄₂. At the same time, the contraction force is greater than the intermolecular force in a transverse direction TD₄₂ perpendicular to the machine direction of the stretched film. Thus, the polarizing plate 40 tends to contract in the transverse direction TD₄₂.

A common method of cutting the polarizing plates is a punching method (Thomson cutting method). The cutting causes impacts to a peripheral portion (cut cross section) of the polarizing plate, so that stress is generated in the cut cross section, creating damage therein. Presumably, subjecting the polarizing plate 40 provided with a hole 41 to a heat shock test to verify the durability will apply stress that splits the damaged portion in the transverse direction TD₄₂ and cause a crack 44 in the machine direction MD₄₂ as shown in FIG. 6. In other words, presumably, the contraction force will be greater as the length of the polarizing plate 40 in the transverse direction TD₄₂ of the stretched film 42 is longer, and the crack 44 will be thus likely to occur.

The present inventors conducted more studies, and found that the stress that is applied to the portion where the hole is formed becomes smaller as the thickness of the stretched film constituting the polarizing plate is smaller, making the polarizing plate less susceptible to cracking.

The present inventors considered all the results of these studies, and found the following findings: in the case of a pair of polarizing plates disposed in crossed Nicols, when one polarizing plate whose length in the direction perpendicular to the machine direction of the stretched film is longer is configured such that the thickness of the stretched film constituting the polarizing plate is smaller than the thickness of the stretched film constituting the other polarizing plate, the polarizing plates are less susceptible to cracking even when subjected to a heat shock test. Thus, the present inventors arrived at an idea that can successfully solve the problems described above and completed the present invention.

Specifically, an embodiment of the present invention provides a liquid crystal display panel sequentially including: a first polarizing plate including a first stretched film and provided with a hole; a liquid crystal panel; and a second polarizing plate including a second stretched film and provided with a hole, wherein a machine direction of the first stretched film is perpendicular to a machine direction of the second stretched film, a length of the first polarizing plate in a direction perpendicular to the machine direction of the first stretched film is longer than a length of the second polarizing plate in a direction perpendicular to the machine direction of the second stretched film, and a thickness of the first stretched film is smaller than a thickness of the second stretched film.

Another embodiment of the present invention provides a method of producing a liquid crystal display panel, including: a step of forming a hole in a first polarizing plate including a first stretched film; a step of forming a hole in a second polarizing plate including a second stretched film; and a step of producing a liquid crystal display panel by sequentially stacking the first polarizing plate provided with the hole, a liquid crystal panel, and the second polarizing plate provided with the hole, wherein in the liquid crystal display panel, a machine direction of the first stretched film is perpendicular to a machine direction of the second stretched film, a length of the first polarizing plate in a direction perpendicular to the machine direction of the first stretched film is longer than a length of the second polarizing plate in a direction perpendicular to the machine direction of the second stretched film, and a thickness of the first stretched film is smaller than a thickness of the second stretched film.

### Advantageous Effects of Invention

According to the liquid crystal display panel of the present invention, a decrease in durability and reliability can be inhibited while excellent design ability is maintained. The method of producing a liquid crystal display panel of the present invention can produce a liquid crystal display panel in which the design ability is excellent and a decrease in durability and reliability is inhibited.

### BRIEF DESCRIPTION OF DRAWINGS

FIG. 1 is a schematic perspective view showing an exemplary liquid crystal display panel according to Embodiment 1.

FIG. 2 is a schematic cross-sectional view showing an exemplary liquid crystal display panel according to Embodiment 2.

FIG. 3 is a schematic cross-sectional view showing an exemplary liquid crystal display panel according to Embodiment 3.

FIG. 4 is a schematic cross-sectional view showing an exemplary liquid crystal display panel according to Embodiment 4.

FIG. 5 is a schematic perspective view showing a polarizing plate used in an examination experiment.

FIG. 6 is a schematic plan view showing a polarizing plate that was cracked in the heat shock test.

### DESCRIPTION OF EMBODIMENTS

The present invention is described below in more detail with reference to the drawings in the following embodiments, but is not limited to these embodiments. In the following description, similar symbols are commonly used in different drawings for the same portions or portions with similar functions, and repetitive descriptions are appropriately omitted. In addition, features of the embodiments may be appropriately combined or modified without departing from the gist of the present invention.

### Embodiment 1

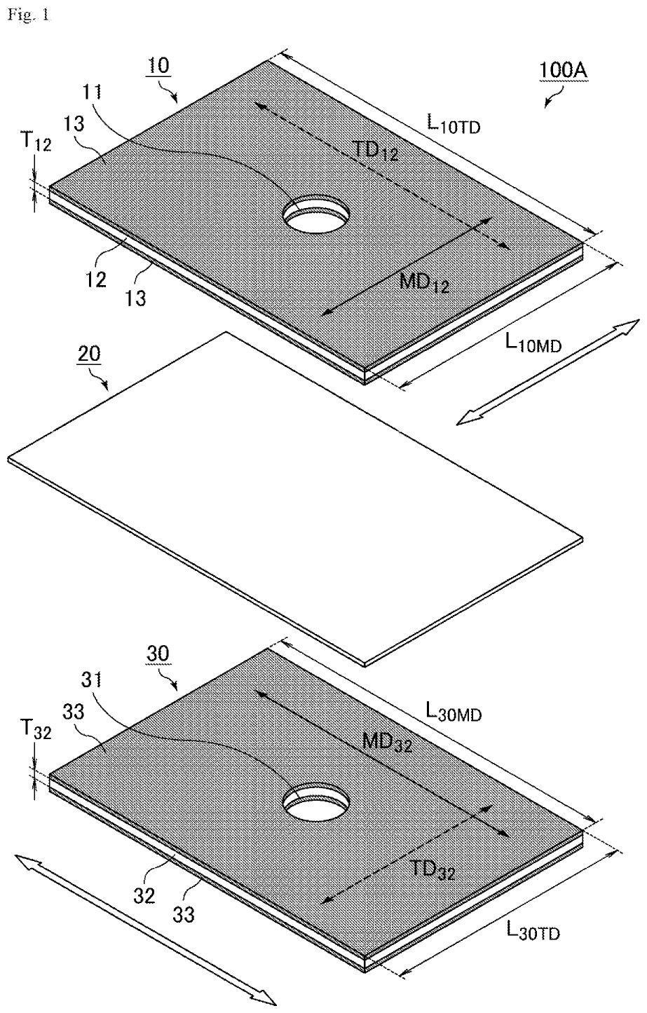

A liquid crystal display panel according to Embodiment 1 is described with reference to FIG. 1. FIG. 1 is a schematic perspective view showing an exemplary liquid crystal display panel according to Embodiment 1. A liquid crystal display panel 100A according to Embodiment 1 sequentially includes a first polarizing plate 10 provided with a hole 11, a liquid crystal panel 20, and a second polarizing plate 30 provided with a hole 31. In FIG. 1, the components are separated from one another, but the first polarizing plate 10 and the second polarizing plate 30 may be bonded to the liquid crystal panel 20 with an adhesive or the like. Herein, the term “polarizing plate” indicates an optical member that allows polarized light in a specific direction to pass therethrough.

The hole 11 is preferably formed in the region surrounded by the first polarizing plate 10 in a plan view. The hole 31 is preferably formed in the region surrounded by the second polarizing plate 30 in a plan view. Additionally, the holes 11 and 31 are preferably at least partially overlapping each other in a plan view.

The hole 11 formed in the first polarizing plate 10 and the hole 31 formed in the second polarizing plate 30 each may have any shape. It may be circular as shown in FIG. 1, or any other shape. The hole 11 and the hole 31 may each have an elliptical shape. Alternatively, the hole 11 and the hole 31 may each have a shape whose perimeter is formed by combining a straight line and a curved line. In order to sufficiently prevent cracking in the first polarizing plate 10 and the second polarizing plate 30 in the heat shock test, preferably, the hole 11 and the hole 31 each have a shape whose perimeter is formed by a curved line (without corners), such as a circular shape or an elliptical shape. The hole 11 and the hole 31 may have the same shape or different shapes. The number of the holes 11 and the number of the holes 31 are not limited. There may be one hole 11 and one hole 31 or multiple holes 11 and multiple holes 31.

The method of forming the holes 11 and 31 is described later, but examples of the method include a punching process that uses a punching die and a method that uses an end mill or laser. The holes 11 and 31 may be formed at the same time when a polarizing plate having a desired shape is cut out from a roll of raw sheet of the polarizing plate.

The first polarizing plate 10 includes a first stretched film 12, and the second polarizing plate 30 includes a second stretched film 32. The first stretched film 12 and the second stretched film 32 can be resin films containing a dichroic substance, for example. Stretching the resin films containing a dichroic substance causes molecules of the dichroic substance to be aligned in the stretching direction, allowing only light polarized in a vibration direction to pass through the films. Examples of the dichroic substance include iodine and organic dyes. Examples of the resin forming the resin films include those containing, for example, polyvinyl alcohol (PVA) or an ethylene-vinyl alcohol copolymer. Of these, the first stretched film 12 and the second stretched film 32 preferably contain polyvinyl alcohol. The polyvinyl alcohol can be obtained by saponifying polyvinyl acetate.

A machine direction MD₁₂ of the first stretched film 12 is perpendicular to a machine direction MD₃₂ of the second stretched film 32. In other words, the first polarizing plate 10 and the second polarizing plate 30 are disposed in crossed Nicols in such a manner that their absorption axes are perpendicular to each other. In FIG. 1, the white double-headed arrow near the first polarizing plate 10 indicates an absorption axis of the first polarizing plate 10, and the white double-headed arrow near the second polarizing plate 30 indicates an absorption axis of the second polarizing plate 30. Such an arrangement makes it possible to control the alignment of liquid crystal molecules in a liquid crystal layer and adjust the amount of light that passes through the liquid crystal display panel so as to display an image. Herein, that “the two machine directions are perpendicular to each other” means that the angle formed between the two machine directions is within the range of 90±1°, preferably within the range of 0±0.5°, particularly preferably 90° (i.e., completely perpendicular to each other). The “machine direction” indicates the flow direction of resin during molding of the stretched film. The machine direction is also referred to as a machine axis direction. For example, when the first polarizing plate 10 and the second polarizing plate 30 are absorptive polarizing plates, the machine direction MD₁₂ of the first stretched film 12 is parallel to the direction of the absorption axis of the first polarizing plate 10, and the machine direction MD₃₂ of the second stretched film 32 is parallel to the direction of the absorption axis of the second polarizing plate 30. The direction perpendicular to the machine direction is also referred to as a transverse direction and is parallel to the direction of a transmission axis.

A length L_{10TD} of the first polarizing plate 10 in the direction (a transverse direction TD₁₂) perpendicular to the machine direction MD₁₂ of the first stretched film 12 is longer a length L_{30TD} of the second polarizing plate 30 in the direction (a transverse direction TD₃₂) perpendicular to the machine direction MD₃₂ of the second stretched film 32. The length L_{10TD} is the length of a segment connecting intersections between a straight line extending in the direction perpendicular to the machine direction MD₁₂ of the first stretched film 12 of the first polarizing plate 10 and passing through the hole 11 provided in the first polarizing plate 10 and the periphery of the first polarizing plate 10. When there are multiple such segments, the length of the longest segment is regarded as the length L_{10TD}. The length L_{30TD} is the length of a segment connecting intersections between a straight line extending in the direction perpendicular to the machine direction MD₃₂ of the second stretched film 32 of the second polarizing plate 30 and passing through the hole 31 provided in the second polarizing plate 30 and the periphery of the second polarizing plate 30. When there are multiple such segments, the length of the longest segment is regarded as the length L_{30TD}. When there are multiple holes 11 and multiple holes 31, each of the length L_{10TD} and the length L_{30TD} is only required to pass through at least one hole.

The length L_{10TD} of the first polarizing plate 10 in the transverse direction TD₁₂ is not limited. Yet, as shown in FIG. 1, the length L_{10TD} is preferably longer than the length L_{10MD} of the first polarizing plate 10 in the machine direction MD₁₂. Such a structure can be easily achieved by setting the longitudinal direction of the first polarizing plate 10 as the transverse direction TD₁₂ and setting the transverse direction of the first polarizing plate 10 as the machine direction MD₁₂.

The length L_{30TD} of the second polarizing plate 30 in the transverse direction TD₃₂ is not limited. Yet, as shown in FIG. 1, the length L_{30TD} is preferably shorter than a length L_{30MD} of the second polarizing plate 30 in the machine direction MD₃₂. Such a structure can be easily achieved by setting the longitudinal direction of the second polarizing plate 30 as the machine direction MD₃₂ and setting transverse direction of the second polarizing plate 30 as the transverse direction TD₃₂.

The length L_{10TD} of the first polarizing plate 10 in the direction perpendicular to the machine direction MD₁₂ of the first stretched film 12 is preferably not less than 1.1 times the length L_{30TD} of the second polarizing plate 30 in the direction perpendicular to the machine direction MD₃₂ of the second stretched film 32. The length L_{10TD} is more preferably not less than 1.2 times the length L_{30TD}. The length L_{10TD} relative to the length L_{30TD} is not limited, but, it is not more than 10 times the length L_{30TD}, for example.

A thickness T₁₂ of the first stretched film 12 is smaller than a thickness T₃₂ of the second stretched film 32. The results of an examination experiment on the durability of the polarizing plates (described later) show that the polarizing plate tends to be more susceptible to cracking as its length in the transverse direction of the stretched film is longer. The polarizing plate also tends to be more susceptible to cracking as the thickness of the stretched film is greater. Thus, when the polarizing plate whose length in the direction perpendicular to the machine direction of the stretched film is longer is configured such that the thickness of the stretched film constituting the polarizing plate is smaller than the thickness of the stretched film constituting the other polarizing plate, it is possible to improve the durability of the polarizing plate against the heat shock test. The thickness T₁₂ and the thickness T₃₂ can be measured by an optical microscope or an electron microscope, for example.

The thickness T₁₂ of the first stretched film 12 is preferably not more than 0.8 times the thickness T₃₂ of the second stretched film 32. When the thickness T₁₂ of the first stretched film 12 is not more than 0.8 times the thickness T₃₂ of the second stretched film 32, cracking in the first polarizing plate 10 can be effectively inhibited. The thickness T₁₂ of the first stretched film 12 is more preferably not more than 0.6 times the thickness T₃₂ of the second stretched film 32. The lower limit of the thickness T₁₂ of the first stretched film 12 is not limited, but it is not less than 0.1 times the thickness T₃₂ of the second stretched film 32, for example.

The thickness T₁₂ of the first stretched film 12 is not limited as long as it is smaller than the thickness T₃₂ of the second stretched film 32, but it may be 1 μm to 80 μm, for example. The thickness T₁₂ of the first stretched film 12 is more preferably 3 μm or more and more preferably 40 μm or less. Recent liquid crystal display panels for mobile devices have thinner profiles, so that the thickness T₁₂ is more preferably 12 μm or less.

The thickness T₃₂ of the second stretched film 32 is not limited as long as it is greater than the thickness T₁₂ of the first stretched film 12, but it may be 1 μm to 80 μm, for example. The thickness T₃₂ of the second stretched film 32 is more preferably 60 μm or less. Recent liquid crystal display panels for mobile devices have thinner profiles, so that the thickness T₃₂ is more preferably 50 μm or less.

The first polarizing plate 10 and the second polarizing plate 30 each may have any shape, as long as the length L_{10TD} is longer than the length L_{30TD}. In FIG. 1, the first polarizing plate 10 and the second polarizing plate 30 each have a rectangular shape, but these polarizing plates may each have a shape formed with straight lines, a shape formed with a curved line, or a shape formed by combining a straight line and a curved line. The shape of the first polarizing plate 10 and the shape of the second polarizing plate 30 refer to the perimeter shapes of the respective polarizing plates.

The first polarizing plate 10 may further have a first film on at least one of a liquid crystal panel 20 side of the first stretched film 12 or the side opposite to the liquid crystal panel 20 side of the first stretched film 12. The second polarizing plate 30 may further have a second film on at least one of the liquid crystal panel 20 side of the second stretched film 32 or the side opposite to the liquid crystal panel 20 side of the second stretched film 32.

Examples of the first film and the second film include a protection film, a film having a phase difference, a brightness improvement film, a laminate of these films, and films having these functions. The protection film protects the first stretched film 12 and/or the second stretched film 32. The film having a phase difference is a birefringent element that creates a phase difference between polarized components perpendicular to each other. The film having a phase difference is not limited. Examples include a λ/2 plate, a λ/4 plate, and a combination of these plates. The brightness improvement film is a film that scatters incident light to improve the brightness of liquid crystal display panel.

In Embodiment 1, a case where protection films are included as the first film and the second film is described. Examples of protection films 13 and 33 include films containing cellulose resin such as diacetyl cellulose or triacetyl cellulose (TAC); films containing (meth) acrylic resin; films containing cycloolefin resin; films containing olefin resin such as polypropylene; films containing ester resin such as polyethylene terephthalate resin; films containing polyamide resin; films containing polycarbonate resin; and films containing a copolymer of these resins. Of these, the protection films 13 and 33 preferably contain triacetyl cellulose. The protection films 13 and 33 may have any thickness. For example, the thickness may be 10 μm to 200 μm. In order to improve the durability, the protection films 13 and 33 are preferably films not having a phase difference.

The protection film 13 may be disposed on the side opposite to the liquid crystal panel 20 side of the first stretched film 12. Alternatively, the protection film 33 may be disposed on the side opposite to the liquid crystal panel 20 side of the second stretched film 32. In order to improve the durability, as shown in FIG. 1, the first stretched film 12 preferably includes the protection film 13 containing TAC on each side thereof, and preferably includes the protection film 33 containing TAC on each side of the second stretched film 32. More preferably, the first polarizing plate 10 includes a protection film containing TAC on each side of the first stretched film 12 containing PVA. More preferably, the second polarizing plate 30 includes a protection film containing TAC on each side of the second stretched film 32 containing PVA. When the protection films 13 and 33 are TAC films that are highly adhesive to PVA, the first polarizing plate 10 and the second polarizing plate 30 can be less susceptible to cracking.

The liquid crystal panel 20 has, for example, a structure in which a liquid crystal layer (not shown) is sandwiched between a pair of substrates. The substrates are bonded to each other with a sealing material so as to sandwich the liquid crystal layer containing liquid crystal molecules between the substrates. The type of the pair of substrates constituting the liquid crystal panel 20 is not particularly limited. Examples thereof include a combination of a thin-film transistor array substrate and a color filter substrate.

The thin-film transistor array substrate may have a structure in which components such as thin-film transistor elements, pixel electrodes, and various conductive lines (such as scanning lines and signal lines) are disposed on a glass substrate. A transparent substrate such as a plastic substrate may be used instead of the glass substrate.

The structure of a semiconductor layer in each thin-film transistor element is not particularly limited. For example, an amorphous silicon semiconductor, a low-temperature polysilicon semiconductor, or an oxide semiconductor may be used. Examples of materials of the oxide semiconductor include a compound formed from indium, gallium, zinc, and oxygen, and a compound formed from indium, zinc, and oxygen. In the case where a compound formed from indium, gallium, zinc, and oxygen is used for the oxide semiconductor, the amount of off-leakage current is small. Thus, once voltage is applied, pause driving can be performed in which the voltage-applied state is held until a next data signal (voltage) is written (applied). Therefore, in terms of low power consumption, it is preferred to use a compound formed from indium, gallium, zinc, and oxygen for the oxide semiconductor.

The color filter substrate may have a structure in which components such as color filter layers and black masks (light shielding layers) are disposed on a glass substrate. A transparent substrate such as a plastic substrate may be used instead of the glass substrate. The combination of colors of the color filter layers is not particularly limited. Examples thereof include a combination of red, green, and blue and a combination of red, green, blue, and yellow. The color filter substrate may further include multiple pixel electrodes disposed thereon.

The liquid crystal panel 20 may be provided with a hole. In such a case, in order to provide a larger display region, preferably, a hole to be formed in the liquid crystal panel 20 is smaller than at least one of the hole 11 or 31 and is formed at a position overlapping the holes 11 and 31 in a plan view of the liquid crystal display panel 100A.

The liquid crystal display panel of the present invention can achieve high design ability, and thus can be suitably used as, for example, a watch or clock display panel, a vehicle meter display, an operation screen of a game console, or the like.

The liquid crystal display panel 100A, when further combined with a backlight, an external circuit, and the like, can be used as a liquid crystal display device. Which side of the liquid crystal display panel 100A is the front or back is not limited. In the liquid crystal display device, the first polarizing plate 10 side of the liquid crystal display panel 100A may be the front side (observer side) of the liquid crystal display device, and the second polarizing plate 30 side may be the back side of the liquid crystal display device. Alternatively, the second polarizing plate 30 side of the liquid crystal display panel 100A may be the front side of the liquid crystal display device, and the first polarizing plate 10 side may be the back side of the liquid crystal display device.

The display mode of the liquid crystal display device is not limited. Examples thereof include IPS (in-plane switching) mode, FFS (fringe field switching) mode, VA (vertical alignment) mode, TN (twisted nematic) mode, and UV2A (ultra-violet induced multi-domain vertical alignment) mode.

### Embodiment 2

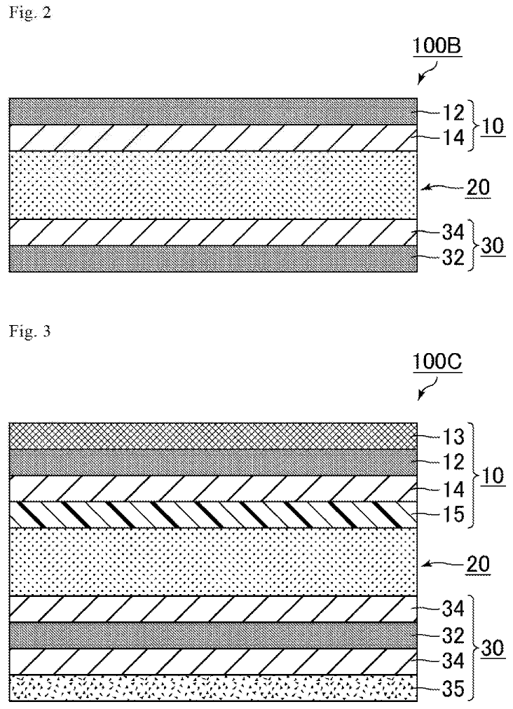

A liquid crystal display panel according to Embodiment 2 is described with reference to FIG. 2. FIG. 2 is a schematic cross-sectional view showing an exemplary liquid crystal display panel according to Embodiment 2.

The first polarizing plate 10 may further include a coating layer on at least one of the liquid crystal panel 20 side of the first stretched film 12 or the side opposite to the liquid crystal panel 20 side of the first stretched film 12, the coating layer being in contact with the first stretched film 12. Additionally, the second polarizing plate 30 may further include a coating layer on at least one of the liquid crystal panel 20 side of the second stretched film 32 or the side opposite to the liquid crystal panel 20 side of the second stretched film 32, the coating layer being in contact with the first stretched film 32. A coating layer formed to be in contact with the first stretched film 12 and/or the second stretched film 32 can inhibit contraction of the first stretched film 12 and/or the second stretched film 32, making the polarizing plates less susceptible to cracking.

As shown in FIG. 2, in a liquid crystal display panel 100B according to Embodiment 2, the first polarizing plate 10 includes a coating layer 14 on the liquid crystal panel 20 side of the first stretched film 12, the coating layer 14 being in contact with the first stretched film 12, and the second polarizing plate 30 includes a coating layer 34 on the liquid crystal panel 20 side of the second stretched film 32, the coating layer 34 being in contact with the second stretched film 32. The coating layers 14 and 34 present on the respective liquid crystal panel 20 sides can improve adhesion between the first stretched film 12 and the liquid crystal panel 20 and adhesion between the second stretched film 32 and the liquid crystal panel 20, respectively, making the first polarizing plate 10 and the second polarizing plate 30 less susceptible to cracking. In order to improve the durability, preferably, the coating layer 14 is formed on each side of the first stretched film 12 such that each coating layer 14 is in contact with the first stretched film 12. Preferably, the coating layer 34 is formed on each side of the second stretched film 32 such that each coating layer 34 is in contact with the second stretched film 32.

Examples of the coating layers 14 and 34 include layers containing polyester resin, acrylic resin, or a polycarbonate. The coating layers 14 and 34 each have a thickness of 0.3 μm to 10 μm, for example. A more preferred lower limit of the thickness of each of the coating layers 14 and 34 is 0.5 μm, and a more preferred upper limit thereof is 5 μm.

### Embodiment 3

A liquid crystal display panel according to Embodiment 3 is described with reference to FIG. 3. FIG. 3 is a schematic cross-sectional view showing an exemplary liquid crystal display panel according to Embodiment 3. As shown in FIG. 3, in a liquid crystal display panel 100C according to Embodiment 3, the first polarizing plate 10 includes a viewing angle compensation film 15 as the first film. The second polarizing plate 30 includes a brightness improvement film 35 as the second film.

When the first film is the viewing angle compensation film 15, the viewing angle compensation film 15 is preferably disposed closer to the liquid crystal panel 20 than the first stretched film 12 is.

The viewing angle compensation film 15 is preferably a film having a phase difference. Because of the phase difference, the viewing angle can be corrected, which can improve viewing angle characteristics. The viewing angle compensation film 15 is not limited. Examples include a λ/2 plate, a λ/4 plate, and a combination of these. The viewing angle compensation film 15 may be, for example, a film containing a cycloolefin polymer (COP film).

When the second film is the brightness improvement film 35, the brightness improvement film 35 is preferably disposed on the side opposite to the liquid crystal panel 20 side of the second stretched film 32. Additionally, the brightness improvement film 35 is preferably disposed on the outermost surface of the second polarizing plate 30 on the side opposite to the liquid crystal panel 20 side.

Examples of the brightness improvement film 35 include a brightness enhancement film (BEF) (e.g., one available from 3M), a dual brightness enhancement film (DBEF) (e.g., one available from 3M), and an APF film (e.g., one available from 3M). A polarizing plate with an APCF (brightness improvement film) (e.g., one available from Nitto Denko Corporation) can also be used.

For example, when the protection film 13 is a film containing TAC, since such a film has good adhesion to a PVA film, contact between the first stretched film 12 and the protection film 13 as shown in FIG. 3 provides sufficient adhesion therebetween in the liquid crystal display panel 100C. When the first polarizing plate 10 includes the viewing angle compensation film 15 such as a COP film, the coating layer 14 may be provided between the first stretched film 12 and the viewing angle compensation film 15 in order to improve adhesion between the first stretched film 12 and the viewing angle compensation film 15. In other words, the first polarizing plate 10 may include the coating layer 14 on the liquid crystal panel 20 side of the first stretched film 12, the coating layer 14 being in contact with the first stretched film 12.

In Embodiment 3, for example, the viewing angle compensation film 15 may be a COP film, and the brightness improvement film 35 may be an APF. For example, as shown in FIG. 3, when the brightness improvement film 35 is disposed on the outermost surface of the second polarizing plate 30 on the side opposite to the liquid crystal panel 20 side, the brightness improvement film 35 may be used as a protection film. In order to improve adhesion between the second stretched film 32 and the brightness improvement film 35, the coating layer 34 may be provided between the second stretched film 32 and the brightness improvement film 35. In other words, the second polarizing plate 30 may include the coating layer 34 on the side opposite to the liquid crystal panel 20 side of the second stretched film 32, the coating layer 34 being in contact with the second stretched film 32. Further, the second polarizing plate 30 may also include the coating layer 34 on the liquid crystal panel 20 side of the second stretched film 32, the coating layer 34 being in contact with the second stretched film 32.

Further, an adhesive layer may be provided between the coating layer 34 and the brightness improvement film 35. The adhesive layer is not limited, and one commonly used in the liquid crystal display panel field can be used.

In Embodiment 3, for example, the liquid crystal display panel 100C may be provided with a backlight near the second polarizing plate 30. In this case, the second polarizing plate 30 preferably includes the brightness improvement film 35 on its outermost surface on the side opposite to the liquid crystal panel 20 side.

### Embodiment 4

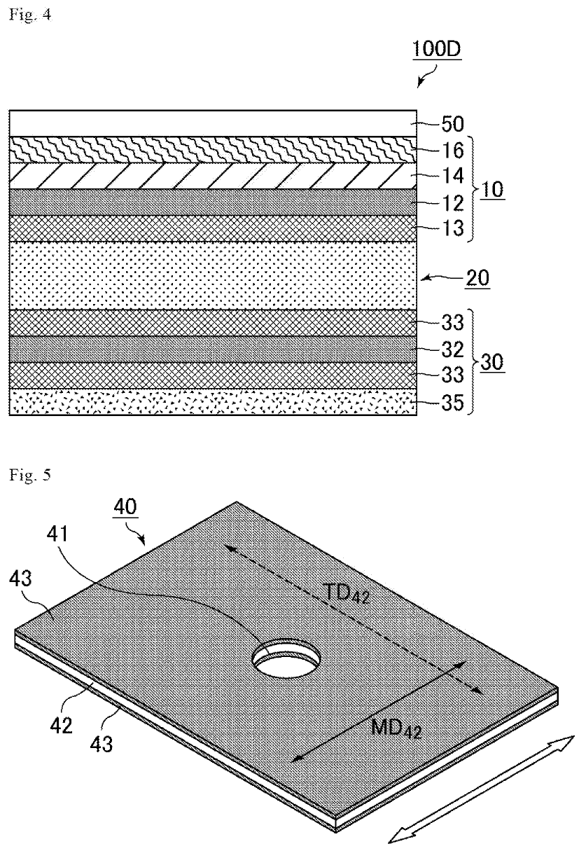

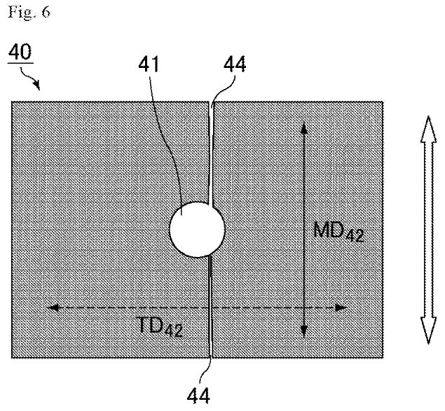

A liquid crystal display panel according to Embodiment 4 is described with reference to FIG. 4. FIG. 4 is a schematic cross-sectional view showing an exemplary liquid crystal display panel according to Embodiment 4. In a liquid crystal display panel 100D, the first polarizing plate 10 includes a sunglasses accommodating film 16 as the first film.

The liquid crystal display panel 100D may further include a transparent substrate on the side opposite to the liquid crystal panel 20 side of the first polarizing plate 10, or on the side opposite to the liquid crystal panel 20 side of the second polarizing plate 30. Embodiment 4 describes a case where the transparent substrate is disposed on the side opposite to the liquid crystal panel 20 side of the first polarizing plate 10. The length L_{10TD} of the first polarizing plate 10 in the direction (the transverse direction TD₁₂) perpendicular to the machine direction MD₁₂ of the first stretched film 12 is longer than the length L_{30TD} of the second polarizing plate 30 in the direction (the transverse direction TD₃₂) perpendicular to the machine direction MD₃₂ of the second stretched film 32. Thus, the first polarizing plate 10 is more susceptible to cracking than the second polarizing plate 30. Therefore, in the liquid crystal display panel 100D, the transparent substrate is preferably disposed on the side opposite to the liquid crystal panel 20 side of the first polarizing plate 10, which can further improve the durability of the liquid crystal display panel 100D.

The transparent substrate is a member different from the first polarizing plate 10 and the second polarizing plate 30. The transparent substrate is preferably disposed on one outermost surface of the liquid crystal display panel 100D on the side opposite to the liquid crystal panel 20 side of the first polarizing plate 10, or is disposed on the other outermost surface of the liquid crystal display panel 100D on the side opposite to the liquid crystal panel 20 side of the second polarizing plate 30. The transparent substrate may or may not be provided with a hole. When forming a hole in the transparent substrate, the hole is preferably formed at a position overlapping the holes 11 and 31.

The transparent substrate is not limited as long as it is highly resistant to scratching and is transparent. Examples include glass substrates and polycarbonate substrates. In order to improve the durability, the transparent substrate preferably has no phase difference. As shown in FIG. 4, the liquid crystal display panel 100D includes a cover glass 50 on the side opposite to the liquid crystal panel 20 side.

Further, an adhesive layer (not shown) may be provided between the cover glass 50 and the sunglasses accommodating film 16. The adhesive layer may be, for example, an optically clear adhesive (OCA) sheet, optically clear resin (OCR), or the like.

The sunglasses accommodating film 16 may be a λ/4 plate. When the sunglasses accommodating film 16 is a λ/4 plate, the sunglasses accommodating film 16 may be disposed on the side opposite to the liquid crystal panel 20 side of the first stretched film 12. The λ/4 plate disposed as above can convert an outgoing light into circularly polarized light to prevent the image from becoming invisible due to interference between an axis of sunglasses and an axis of the first stretched film 12. The sunglasses accommodating film 16 may be a COP film.

In Embodiment 4 (but not limited only in Embodiment 4), for example, when the brightness improvement film 35 is disposed on the outermost surface of the second polarizing plate 30 on the side opposite to the liquid crystal panel 20 side, an adhesive layer (not shown) may be further provided between the stretched film 32 (in FIG. 4, the protection film 33) and the brightness improvement film 35.

The adhesive layer is not limited. It may be a light-diffusing adhesive that contains light-diffusing fine particles to provide a better light-diffusing effect. Use of the light-diffusing adhesive can reduce moiré due to interference with light from a backlight.

The light-diffusing fine particles are not limited. Examples include fine particles containing an inorganic compound and fine particles containing an organic compound. Examples of the inorganic compound include aluminum oxide and silicon oxide. Examples of the organic compound include melamine resin, acrylic resin, polycarbonate, polyethylene resin, polystyrene resin, polyvinyl chloride resin, and silicone resin.

In the case of Embodiment 4, for example, the liquid crystal display panel 100D may be provided with a backlight near the second polarizing plate 30. In this case, the transparent substrate may be located on the side opposite to the liquid crystal panel 20 side of the first polarizing plate 10, and the second polarizing plate 30 may include the brightness improvement film 35 on its outermost surface on the side opposite to the liquid crystal panel 20 side.

The backlight may be disposed on the liquid crystal display panel near the first polarizing plate. When the first film is a brightness improvement film, the brightness improvement film may be disposed on the outermost surface of the first polarizing plate on the side opposite to the liquid crystal panel side. The first polarizing plate may include the brightness improvement film on its outermost surface on the side opposite to the liquid crystal panel side, and the transparent substrate may be located on the side opposite to the liquid crystal panel side of the second polarizing plate.

Hereinafter, methods of producing the liquid crystal display panels according to Embodiments 1 to 4 are described. Another embodiment of the present invention provides a method of producing a liquid crystal display panel, including: a step of forming a hole in a first polarizing plate including a first stretched film; a step of forming a hole in a second polarizing plate including a second stretched film; and a step of producing a liquid crystal display panel by sequentially stacking the first polarizing plate provided with the hole, a liquid crystal panel, and the second polarizing plate provided with the hole, wherein in the liquid crystal display panel, a machine direction of the first stretched film is perpendicular to a machine direction of the second stretched film, a length of the first polarizing plate in a direction perpendicular to the machine direction of the first stretched film is longer than a length of the second polarizing plate in a direction perpendicular to the machine direction of the second stretched film, and a thickness of the first stretched film is smaller than a thickness of the second stretched film.

The step of forming a hole in the first polarizing plate and the step of forming a hole in the second polarizing plate may include punching using a punching die. The punching die that can be used is, for example, a Thomson punching die with a Thomson blade, a pinnacle punching die with a pinnacle blade, or an engraving die with an engraving blade. Damage by the punching to the first polarizing plate and the second polarizing plate is large, but the punching method has higher mass productivity than a method that uses an end mill or laser.

The step of forming a hole in the first polarizing plate and the second polarizing plate may be performed using an end mill. With use of an end mill, it is possible to form a hole while damage to the first polarizing plate and the second polarizing plate is controlled, as compared to the punching method. Use of an end mill also achieves higher mass productivity than a laser method described below.

According to the method that uses an end mill (hereinafter also referred to as an end mill method), for example, when forming a hole in the first polarizing plate, at least one of the first polarizing plate or the end mill blade is moved while a rotating end mill blade is pressed against the first polarizing plate, whereby the first polarizing plate is cut and a hole is formed. The end mill blade can be a known one. The material of the end mill blade is not limited, and may be suitably selected according to the material of the first polarizing plate 10. The blade diameter of the end mill blade is not limited, and may be suitably selected according to the size of the intended hole to be formed.

The step of forming a hole in the first polarizing plate and the step of forming a hole in the second polarizing plate may be performed using a laser. With use of a laser, it is possible to form a hole while damage to the first polarizing plate and the second polarizing plate is controlled, as compared to the punching method.

The method that uses the laser (hereinafter also referred to as a laser method) is not limited. Yet, for example, a laser that can emit light having a wavelength in the range of 150 nm to 11 μm is used. Specific examples include a gas laser such as a CO₂ laser; a solid-state laser such as a YAG laser; and a semiconductor laser. Preferably, CO₂ laser is used. The laser light emitting conditions can be optionally set to suitable conditions according to the laser to be used, for example. In the case of using a CO₂ laser, the output is preferably 10 W to 1000 W, more preferably 100 W to 400 W. Use of the laser method can provide a smooth cut surface, which can reduce the occurrence of a starting point of cracking. A device that emits the laser light may be, for example, a CO₂ laser device available from Mitsuboshi Diamond Industrial Co., Ltd.

When the first polarizing plate includes the first film and/or the coating layer, a hole is formed in the first polarizing plate after the first film and/or the coating layer is formed. When the second polarizing plate includes the second film and/or the coating layer, a hole is formed in the second polarizing plate after the second film and/or the coating layer are/is formed.

Prior to the step of forming a hole in the first polarizing plate or the step of forming a hole in the second polarizing plate, the method may include a step of stacking a transparent substrate on the first polarizing plate or the second polarizing plate. When forming a hole in the transparent substrate, the transparent substrate may be first stacked on the first polarizing plate or the second polarizing plate, and then the hole may be formed in the transparent substrate simultaneously as the hole is formed in the first polarizing plate or the second polarizing plate.

In the step of forming a hole in the first polarizing plate, the first polarizing plate may be cut out into a desired shape while a hole is formed in the first polarizing plate. In the step of forming a hole in the second polarizing plate, the second polarizing plate may be cut out into a desired shape while a hole is formed in the second polarizing plate.

In the step of producing a liquid crystal display panel, the first polarizing plate provided with a hole, a liquid crystal panel, and the second polarizing plate provided with a hole are sequentially stacked. The method of stacking is not limited. Examples include a method in which an adhesive is applied between the first polarizing plate and the liquid crystal panel and between the liquid crystal panel and the second polarizing plate, and a method in which an adhesive sheet is disposed between those. The type of the adhesive and the type of the adhesive sheet can be suitably selected.

In the step of producing a liquid crystal display panel, the first polarizing plate and the second polarizing plate are bonded to the liquid crystal panel such that the machine direction of the first stretched film is perpendicular to the machine direction of the second stretched film and such that the length of the first polarizing plate in the direction perpendicular to the machine direction of the first stretched film is longer than the length of the second polarizing plate in the direction perpendicular to the machine direction of the second stretched film. In this manner, a liquid crystal display panel not susceptible to cracking even when subjected to a heat shock test can be produced.

The step of producing a liquid crystal display panel may include a step of stacking a transparent substrate on the side opposite to the liquid crystal panel side of the first polarizing plate provided with a hole, or on the side opposite to the liquid crystal panel side of the second polarizing plate provided with a hole. When forming a hole in the transparent substrate, the transparent substrate may be bonded to the first polarizing plate provided with a hole or the second polarizing plate provided with a hole after a hole is formed in the transparent substrate.

After the step of producing a liquid crystal display panel, the resulting liquid crystal display panel may be cut into a desired shape.

### Examples

The present invention is more specifically described below with reference to examples, but the present invention is not limited to these examples.

### Examination Experiment

The relation between the length of the polarizing plate in the transverse direction of the stretched film, the thickness of the stretched film, and the durability of the polarizing plate was examined as described below.

The polarizing plate 40 for a heat shock test was a PVA polarizing plate including a PVA film as a stretched film and including one 25 μm-thick TAC film and one 40 μm-thick TAC film as protection films, one on each side of the PVA film. The thickness of the PVA film was 7 μm, 12 μm, 22 μm, or 28 μm. The polarizing plates each including one of these four PVA films had a length of 50 mm in the direction of the machine direction (MD). These polarizing plates were examined by varying the length in the direction of the transverse direction (TD) as shown in Table 1 below. Using a Thomson blade, the hole 41 having a curvature radius of 1 mm was punched in each polarizing plate, whereby test pieces were obtained.

Each test piece was subjected to a heat shock test under the following conditions. The heat shock test was performed using a thermal shock chamber available from Espec Corporation (product name: TSA-71L-A). Specifically, each polarizing plate was maintained in an environment at a temperature of 85° C. for 30 minutes, and subsequently, was maintained in an environment at a temperature of −40° C. for 30 minutes. This process was performed as one cycle. The switching time between the environment at a temperature of 85° C. and the environment at a temperature of −40° C. was 30 minutes. Each polarizing plate was subjected to 6 cycles, 72 cycles, 120 cycles, 240 cycles, and 500 cycles of the heat shock test. After each set of cycles of the heat shock test, each polarizing plate was visually observed for the occurrence of cracks. The result was regarded as good when no cracking occurred, and the result was regarded as poor when cracking occurred. The test results are shown in Table 1 below.

TABLE 1

| Thickness of | Length in | Number of heat shock tests | | | | |
|---|---|---|---|---|---|---|
| stretched film (μm) | TD (mm) | 6 cycles | 72 cycles | 120 cycles | 240 cycles | 500 cycles |
| 7 | 30 | Good | Good | Good | Good | Good |
| | 40 | Good | Good | Good | Good | Good |
| | 50 | Good | Good | Good | Good | Good |
| | 60 | Good | Good | Good | Good | Poor |
| | 70 | Good | Good | Good | Good | Poor |
| | 80 | Good | Good | Good | Good | Poor |
| 12 | 30 | Good | Good | Good | Good | Good |
| | 40 | Good | Good | Good | Good | Good |
| | 50 | Good | Good | Good | Good | Good |
| | 60 | Good | Good | Good | Poor | Poor |
| | 70 | Good | Good | Good | Poor | Poor |
| | 80 | Good | Good | Good | Poor | Poor |
| 22 | 30 | Good | Good | Good | Good | Good |
| | 40 | Good | Good | Good | Good | Good |
| | 50 | Good | Good | Good | Good | Good |
| | 60 | Good | Good | Poor | Poor | Poor |
| | 70 | Good | Good | Poor | Poor | Poor |
| | 80 | Good | Good | Poor | Poor | Poor |
| 28 | 30 | Good | Good | Good | Good | Good |
| | 40 | Good | Good | Good | Good | Good |
| | 50 | Good | Good | Good | Good | Good |
| | 60 | Good | Poor | Poor | Poor | Poor |
| | 70 | Good | Poor | Poor | Poor | Poor |
| | 80 | Good | Poor | Poor | Poor | Poor |

As shown in Table 1, according to the results of the examination experiment, it is clear that the polarizing plate is susceptible to cracking when the length in the transverse direction (TD) of the stretched film is longer than the length in the machine direction (MD) of the stretched film. It is also clear that the polarizing plate is more susceptible to cracking when the PVA film is thicker. These results show that cracking can be more effectively inhibited when the length of the polarizing plate is shorter in the transverse direction and that cracking can be reduced by reducing the thickness of the PVA film.

### Example 1

In Example 1, a liquid crystal display panel sequentially including a first polarizing plate, a liquid crystal panel, and a second polarizing plate was produced. The first polarizing plate was an absorptive polarizing plate having a length in the direction of the machine direction of 40 mm and a length in the direction of the transverse direction of 60 mm, including a PVA film having a thickness of 12 μm, and including a 25 μm-thick TAC film on each surface of the PVA film. The second polarizing plate was an absorptive polarizing plate having a length in the machine direction of 60 mm and a length in the transverse direction of 40 mm, including a PVA film having a thickness of 22 μm, and including a 25 μm-thick TAO film on each surface of the PVA film.

Using a Thomson blade, a hole having a curvature radius of 1 mm was punched in the center of each of the first polarizing plate and the second polarizing plate. Subsequently, the first polarizing plate and the second polarizing plate were disposed such that their holes were overlapping each other and their absorption axes were perpendicular to each other, and these polarizing plates were bonded to the respective sides of the liquid crystal panel. Thus, the liquid crystal display panel according to Example 1 was completed.

The liquid crystal display panel according to Example 1 was subjected to a heat shock test with 120 cycles under the same conditions as those for the examination experiment, but no crack was observed.

### ADDITIONAL REMARKS

An embodiment of the present invention provides a liquid crystal display panel sequentially including: a first polarizing plate including a first stretched film and provided with a hole; a liquid crystal panel; and a second polarizing plate including a second stretched film and provided with a hole, wherein a machine direction of the first stretched film is perpendicular to a machine direction of the second stretched film, a length of the first polarizing plate in a direction perpendicular to the machine direction of the first stretched film is longer than a length of the second polarizing plate in a direction perpendicular to the machine direction of the second stretched film, and a thickness of the first stretched film is smaller than a thickness of the second stretched film.

The thickness of the first stretched film may not be more than 0.8 times the thickness of the second stretched film.

The length of the first polarizing plate in the direction perpendicular to the machine direction of the first stretched film may not be less than 1.1 times the length of the second polarizing plate in the direction perpendicular to the machine direction of the second stretched film.

Further, the liquid crystal display panel may include a transparent substrate on the side opposite to the liquid crystal panel side of the first polarizing plate, or on the side opposite to the liquid crystal panel side of the second polarizing plate.

The first polarizing plate may further include a first film at least one of the liquid crystal panel side of the second stretched film or the side opposite to the liquid crystal panel side of the second stretched film.

The first film may be a brightness improvement film, and the brightness improvement film may be disposed on the outermost surface of the first polarizing plate on the side opposite to the liquid crystal panel side.

The first polarizing plate may include the brightness improvement film on its outermost surface on the side opposite to the liquid crystal panel side, and the transparent substrate may be located on the side opposite to the liquid crystal panel side of the second polarizing plate.

The second polarizing plate may further include a second film on at least one of the liquid crystal panel side of the second stretched film or the side opposite to the liquid crystal panel side of the second stretched film.

The second film may be a brightness improvement film, and the brightness improvement film may be disposed on the outermost surface of the second polarizing plate on the side opposite to the liquid crystal panel side.

The transparent substrate may be located on the side opposite to the liquid crystal panel side of the first polarizing plate, and the second polarizing plate may include the brightness improvement film on its outermost surface on the side opposite to the liquid crystal panel side.

The first stretched film and the second stretched film may contain polyvinyl alcohol, and the first film and/or the second film may contain triacetyl cellulose.

The first polarizing plate may further include a coating layer on at least one of the liquid crystal panel side of the first stretched film or the side opposite to the liquid crystal panel side of the first stretched film, the coating layer being in contact with the first stretched film.

The second polarizing plate may further include a coating layer on at least one of the liquid crystal panel side of the second stretched film or the side opposite to the liquid crystal panel side of the second stretched film, the coating layer being in contact with the second stretched film.

Another embodiment of the present invention provides a method of producing a liquid crystal display panel, including: a step of forming a hole in a first polarizing plate including a first stretched film; a step of forming a hole in a second polarizing plate including a second stretched film; and a step of producing a liquid crystal display panel by sequentially stacking the first polarizing plate provided with the hole, a liquid crystal panel, and the second polarizing plate provided with the hole, wherein in the liquid crystal display panel, a machine direction of the first stretched film is perpendicular to a machine direction of the second stretched film, a length of the first polarizing plate in a direction perpendicular to the machine direction of the first stretched film is longer than a length of the second polarizing plate in a direction perpendicular to the machine direction of the second stretched film, and a thickness of the first stretched film is smaller than a thickness of the second stretched film.

The step of forming a hole in the first polarizing plate and the step of forming a hole in the second polarizing plate may include punching using a punching die. The step of forming a hole in the first polarizing plate and the second polarizing plate may use an end mill. The step of forming a hole in the first polarizing plate and the second polarizing plate may be performed using a laser.

### REFERENCE SIGNS LIST

10, 30, 40: polarizing plate
11, 31, 41: hole
12, 32, 42: stretched film
13, 33, 43: protection film
14, 34: coating layer
15: viewing angle compensation film
16: sunglasses accommodating film
20: liquid crystal panel
44: crack
35: brightness improvement film
50: cover glass
100A, 100B, 100C, 100D: liquid crystal display panel
MD₁₂, MD₃₂, MD₄₂: machine direction of stretched film
TD₁₂, TD₃₂, TD₄₂: direction perpendicular to machine direction of stretched film
L_{10TD}, L_{30TD}: length of polarizing plate in direction perpendicular to machine direction of stretched film
T₁₂, T₃₂: thickness of stretched film

1. A liquid crystal display panel sequentially comprising:
a first polarizing plate including a first stretched film and provided with a hole;
a liquid crystal panel; and
a second polarizing plate including a second stretched film and provided with a hole,
wherein a machine direction of the first stretched film is perpendicular to a machine direction of the second stretched film,
a length of the first polarizing plate in a direction perpendicular to the machine direction of the first stretched film is longer than a length of the second polarizing plate in a direction perpendicular to the machine direction of the second stretched film, and
a thickness of the first stretched film is smaller than a thickness of the second stretched film.

2. The liquid crystal display panel according to claim 1,
wherein the thickness of the first stretched film is not more than 0.8 times the thickness of the second stretched film.

3. The liquid crystal display panel according to claim 1,
wherein the length of the first polarizing plate in the direction perpendicular to the machine direction of the first stretched film is not less than 1.1 times the length of the second polarizing plate in the direction perpendicular to the machine direction of the second stretched film.

4. The liquid crystal display panel according to claim 1,
further comprising a transparent substrate on the side opposite to a liquid crystal panel side of the first polarizing plate or on the side opposite to the liquid crystal panel side of the second polarizing plate.

5. The liquid crystal display panel according to claim 1,
wherein the first polarizing plate further comprises a first film on at least one of the liquid crystal panel side of the first stretched film or the side opposite to the liquid crystal panel side of the first stretched film.

6. The liquid crystal display panel according to claim 5,
wherein the first film is a brightness improvement film, and
the brightness improvement film is disposed on an outermost surface of the first polarizing plate on the side opposite to the liquid crystal panel side.

7. The liquid crystal display panel according to claim 6,
wherein the first polarizing plate includes the brightness improvement film on its outermost surface on the side opposite to the liquid crystal panel side, and the transparent substrate is located on the side opposite to the liquid crystal panel side of the second polarizing plate.

8. The liquid crystal display panel according to claim 1,
wherein the second polarizing plate further comprises a second film on at least one of the liquid crystal panel side of the second stretched film or the side opposite to the liquid crystal panel side of the second stretched film.

9. The liquid crystal display panel according to claim 8,
wherein the second film is a brightness improvement film, and
the brightness improvement film is disposed on an outermost surface of the second polarizing plate on the side opposite to the liquid crystal panel side.

10. The liquid crystal display panel according to claim 9,
wherein the transparent substrate is located on the side opposite to the liquid crystal panel side of the first polarizing plate, and the second polarizing plate includes the brightness improvement film on its outermost surface on the side opposite to the liquid crystal panel side.

11. The liquid crystal display panel according to claim 5,
wherein the first stretched film and the second stretched film contain polyvinyl alcohol, and the first film and/or the second film contain/contains triacetyl cellulose.

12. The liquid crystal display panel according to claim 1,
wherein the first polarizing plate further comprises a coating layer on at least one of the liquid crystal panel side of the first stretched film or the side opposite to the liquid crystal panel side of the first stretched film, the coating layer being in contact with the first stretched film.

13. The liquid crystal display panel according to claim 1,
wherein the second polarizing plate further comprises a coating layer on at least one of the liquid crystal panel side of the second stretched film or the side opposite to the liquid crystal panel side of the second stretched film, the coating layer being in contact with the second stretched film.

14. A method of producing a liquid crystal display panel, comprising:
a step of forming a hole in a first polarizing plate including a first stretched film;
a step of forming a hole in a second polarizing plate including a second stretched film; and
a step of producing a liquid crystal display panel by sequentially stacking the first polarizing plate provided with the hole, a liquid crystal panel, and the second polarizing plate provided with the hole,
wherein in the liquid crystal display panel, a machine direction of the first stretched film is perpendicular to a machine direction of the second stretched film,
a length of the first polarizing plate in a direction perpendicular to the machine direction of the first stretched film is longer than a length of the second polarizing plate in a direction perpendicular to the machine direction of the second stretched film, and
a thickness of the first stretched film is smaller than a thickness of the second stretched film.

15. The method of producing a liquid crystal display panel according to claim 14,
wherein the step of forming a hole in the first polarizing plate and the step of forming a hole in the second polarizing plate each includes punching using a punching die.

16. The method of producing a liquid crystal display panel according to claim 14,
wherein the step of forming a hole in the first polarizing plate and the step of forming a hole in the second polarizing plate are performed using an end mill.

17. The method of producing a liquid crystal display panel according to claim 14,
wherein the step of forming a hole in the first polarizing plate and the step of forming a hole in the second polarizing plate are performed using a laser.
